(19) United States
(12) Patent Application Publication
(10) Pub. No.: US 2022/0107926 A1
(43) Pub. Date: Apr. 7, 2022

(54) SCALABLE GEOSPATIAL PLATFORM FOR AN INTEGRATED DATA SYNTHESIS AND ARTIFICIAL INTELLIGENCE BASED EXPLORATION

(71) Applicant: The Climate Corporation, San Francisco, CA (US)

(72) Inventors: STEVEN WARD, Moraga, CA (US); JEFFREY MELCHING, San Francisco, CA (US)

(21) Appl. No.: 17/488,668

(22) Filed: Sep. 29, 2021

Related U.S. Application Data
(60) Provisional application No. 63/088,381, filed on Oct. 6, 2020.

(51) Int. Cl. G06F 16/215; G06F 16/28; G06F 16/29; G06N 20/00; A01B 79/00

(52) U.S. Cl. CPC G06F 16/215; G06F 16/283; A01B 79/005; G06N 20/00; G06F 16/29

(57) ABSTRACT

In some embodiments, a scalable geospatial platform for an integrated data synthesis and artificial intelligence based exploration is disclosed. The platform is configured to implement various techniques for collecting data from different sources and different entities, and processing the data using various approaches, including, for example, the artificial intelligence based approaches.

### BENEFIT CLAIM

This application claims the benefit under 35 U.S.C. § 119(e) of provisional application 63/088,381, filed Oct. 6, 2020, the entire contents of which is hereby incorporated by reference for all purposes as if fully set forth herein. The applicants hereby rescind any disclaimer of claim scope in the parent applications or the prosecution history thereof and advise the USPTO that the claims in this application may be broader than any claim in the parent applications.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2015-2021 The Climate Corporation.

### FIELD OF THE DISCLOSURE

One technical field of the disclosure is a scalable geospatial platform for an integrated data synthesis and artificial intelligence based exploration. Another technical field is an agricultural intelligence system configured to collect data from various sources and to process the collected data using artificial intelligence approaches.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

During the past few years, agricultural computer systems have grown both in terms of covered or subscribed areas and in terms of covered service areas. Examples of such systems include the CLIMATE FIELDVIEW, available from The Climate Corporation, San Francisco, Calif., launched in 2015 in the United States. In 2015, FIELDVIEW covered about 1.5 million acres; in 2016, the coverage grew to 5 million acres; and in 2017, to 25 million acres. Today, FIELDVIEW covers well over 60 million acres globally. To help visualize the coverage, 60 million acres covers about a third of all corn, soybean and cotton acres cultivated in the United States. Since 2018, FIELDVIEW has been launched in three new geographical regions, including Canada, Brazil and multiple European countries. In 2020, FIELDVIEW was launched in Africa and Asia-Pacific markets. But, the global expansion of the agricultural systems is driven not only by the strategic business goals, but also by the market demands and the digital transformations taking place in agriculture.

There is a need, however, to improve the quality, scalability, reliability, and availability of the services provided by the agricultural computer systems before launching a next generation of the services. For example, there is a need to manage a set of unified APIs to offer programmatic access to consistent data, digital farming functionality, quality control, long-term support, mobile and web applications integration and built-in support for testing. The above has prompted the need to re-architect, re-factor, and replace many of the key back-end core services that power the current research and data pipelines today—both for imagery as well as for vector derived machine data.

Usually, the primary shortcomings of the typical pipeline systems are two-fold: (1) lack of proper quality control, filtering, cleaning raw data for research, and (2) inability of porting datasets into Analysis Ready Data (ARD) aggregates for scaled machine learning and modeling. One of the solutions is deployment of the systems' capabilities in a cloud configuration. Further, there is a need to configure the systems in such a way that they could be better positioned to confront the challenges and follow the opportunities of the global expansion by improving the data quality, achieving the operational excellence, fulfilling the API's requirements, and satisfying the needs of the end-users.

In the past, data pipeline systems and storage environments rarely incorporated geospatial standards for data processing and predictive modeling at scale. Typically, the lack of adherence to the basic tenets of geospatial data management has restricted the ability of agricultural researchers to query and process so-called data cubes, which are used for scaled agronomic modeling. These problems have become particularly acute given the exponential growth in total data volumes over the last two years.

### SUMMARY

The appended claims may serve as a summary of the invention.

### BRIEF DESCRIPTION OF THE DRAWINGS

In the drawings:

FIG. 1 depicts an example computer system that is configured to perform the functions described herein, shown in a field environment with other apparatuses with which the system may interoperate.

FIG. 2 depicts two views of an example logical organization of sets of instructions in main memory when an example mobile application is loaded for execution.

FIG. 3 depicts a programmed process by which the agricultural intelligence computer system generates one or more preconfigured agronomic models using agronomic data provided by one or more data sources.

FIG. 4 is a block diagram that depicts a computer system upon which an embodiment of the invention may be implemented.

FIG. 5 depicts an example embodiment of a timeline view for data entry.

FIG. 6 depicts an example embodiment of a spreadsheet view for data entry.

FIG. 7A depicts an example configuration of a scalable geospatial platform.

FIG. 7B depicts an example flow chart of an integrated data synthesis and artificial intelligence based exploration process.

FIG. 8 depicts examples of properties and attributes of machine data.

FIG. 9 depicts examples of multiple layers of data.

FIG. 10 and FIG. 11 depict examples of AgSTAC capabilities.

FIG. 12 depicts examples of geoprocessing environments.

### DETAILED DESCRIPTION

In the following description, for the purposes of explanation, numerous specific details are set forth in order to provide a thorough understanding of the present disclosure. It will be apparent, however, that embodiments may be practiced without these specific details. In other instances, well-known structures and devices are shown in block diagram form in order to avoid unnecessarily obscuring the present disclosure. Embodiments are disclosed in sections according to the following outline:
1. GENERAL OVERVIEW
2. EXAMPLE AGRICULTURAL INTELLIGENCE COMPUTER SYSTEM
   2.1. STRUCTURAL OVERVIEW
   2.2. APPLICATION PROGRAM OVERVIEW
   2.3. DATA INGEST TO THE COMPUTER SYSTEM
   2.4. PROCESS OVERVIEW—AGRONOMIC MODEL TRAINING
   2.5. IMPLEMENTATION EXAMPLE—HARDWARE OVERVIEW
3. SCALABLE GEOSPATIAL PLATFORM FOR AN INTEGRATED DATA SYNTHESIS AND AI BASED EXPLORATION
   3.1. SCALABLE GEOSPATIAL PLATFORM
   3.2. EXAMPLE FLOW CHART
4. MACHINE DATA
5. IMAGERY DATA AND SYSTEMS
6. GEOSPATIAL IMAGERY PROCESSING PLATFORM
7. EXAMPLE SPATIAL COMPONENT
8. EXAMPLE AGSTAC CAPABILITIES
9. EXAMPLE GEOPROCES SING ENVIRONMENT
10. IMPROVEMENTS PROVIDED BY CERTAIN EMBODIMENTS

1. General Overview

Aspects of the disclosure generally relate to a scalable geospatial platform for an integrated data synthesis and artificial intelligence based exploration. The platform is configured to implement various techniques for collecting data from different sources and different entities, and processing the data using various approaches, including, for example, the artificial intelligence based approaches.

In some embodiments, the presented approach implements (1) high quality control, filtering, and cleaning raw data for research purposes, and (2) compiling disparate datasets into Analysis Ready Data (ARD) aggregates for scaled machine learning and modeling. The high quality control, filtering and cleaning raw data for the research purposes is achieved by establishing data science tools configured to ensure the high data quality for information received from agricultural equipment installed in the field. The compiling of the disparate datasets into aggregates may be achieved by using both a geospatial imagery processing platform and machine data pipeline. In some embodiments, the datasets are compiled into aggregates expressed in various data formats, including vector data formats.

In some embodiments, the presented approach sets forth a standard for compiling analysis-ready-geospatial-data in the agricultural industry. It also defines data quality requirements for the agricultural industry partners and continues to expand the scalability of collaboration in agricultural technology.

2. Example Agricultural Intelligence Computer System

2.1. Structural Overview

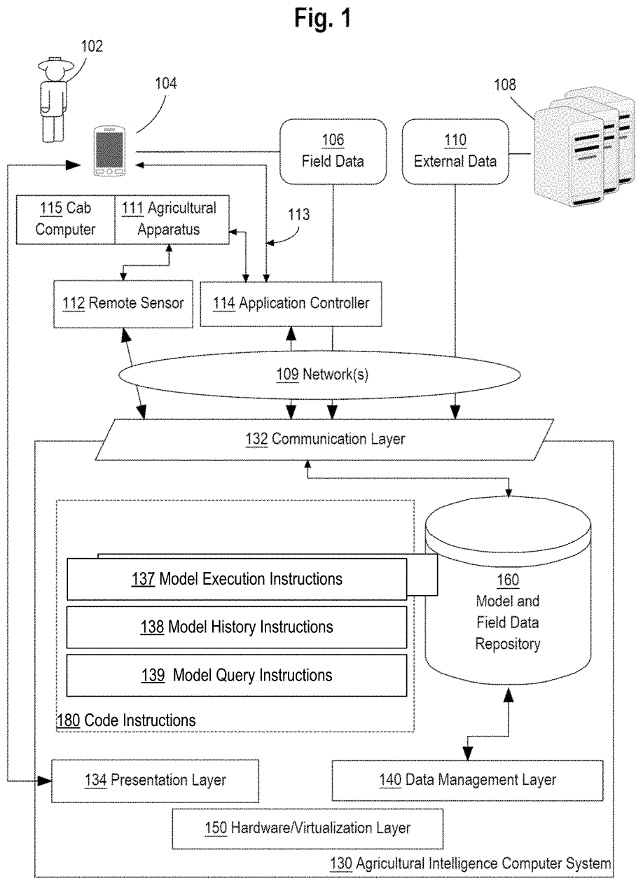

FIG. 1 depicts an example computer system that is configured to perform the functions described herein, shown in a field environment with other apparatuses with which the system may interoperate. In one embodiment, a user 102 owns, operates or possesses a field manager computing device 104 in a field location or associated with a field location such as a field intended for agricultural activities or a management location for one or more agricultural fields. The field manager computer device 104 is programmed or configured to provide field data 106 to an agricultural intelligence computer system 130 via one or more networks 109.

Examples of field data 106 include (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) pesticide data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), and (k) soil, seed, crop phenology, pest and disease reporting, and predictions sources and databases.

An external data server computer 108 is communicatively coupled to agricultural intelligence computer system 130 and is programmed or configured to send external data 110 to agricultural intelligence computer system 130 via the network(s) 109. The external data server computer 108 may be owned or operated by the same legal person or entity as the agricultural intelligence computer system 130, or by a different person or entity such as a government agency, non-governmental organization (NGO), and/or a private data service provider. Examples of external data include weather data, imagery data, soil data, or statistical data relating to crop yields, among others. External data 110 may consist of the same type of information as field data 106. In some embodiments, the external data 110 is provided by an external data server computer 108 owned by the same entity that owns and/or operates the agricultural intelligence computer system 130. For example, the agricultural intelligence computer system 130 may include a data server focused exclusively on the type that might otherwise be obtained from third party sources, such as weather data. In some embodiments, an external data server computer 108 may actually be incorporated within the system 130.

An agricultural apparatus 111 has one or more remote sensors 112 fixed thereon, which sensors are communicatively coupled either directly or indirectly via agricultural apparatus 111 to the agricultural intelligence computer system 130 and are programmed or configured to send sensor data to agricultural intelligence computer system 130. Examples of agricultural apparatus 111 include tractors, combines, harvesters, planters, trucks, fertilizer equipment, unmanned aerial vehicles, and any other item of physical machinery or hardware, typically mobile machinery, and which may be used in tasks associated with agriculture. In some embodiments, a single unit of apparatus 111 may comprise a plurality of sensors 112 that are coupled locally in a network on the apparatus; controller area network (CAN) is an example of such a network that can be installed in combines or harvesters. Application controller 114 is communicatively coupled to agricultural intelligence computer system 130 via the network(s) 109 and is programmed or configured to receive one or more scripts to control an operating parameter of an agricultural vehicle or implement from the agricultural intelligence computer system 130. For instance, a controller area network (CAN) bus interface may be used to enable communications from the agricultural intelligence computer system 130 to the agricultural apparatus 111, such as how the CLIMATE FIELDVIEW, available from The Climate Corporation, San Francisco, Calif., is used. Sensor data may consist of the same type of information as field data 106.

The apparatus 111 may comprise a cab computer 115 that is programmed with a cab application, which may comprise a version or variant of the mobile application for device 104 that is further described in other sections herein. In an embodiment, cab computer 115 comprises a compact computer, often a tablet-sized computer or smartphone, with a color graphical screen display that is mounted within an operator's cab of the apparatus 111. Cab computer 115 may implement some or all of the operations and functions that are described further herein for the mobile computer device 104.

The network(s) 109 broadly represents any combination of one or more data communication networks including local area networks, wide area networks, internetworks, or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. The sensors 112, controller 114, external data server computer 108, and other elements of the system each comprise an interface compatible with the network(s) 109 and are programmed or configured to use standardized protocols for communication across the networks such as TCP/IP, Bluetooth, CAN protocol and higher-layer protocols such as HTTP, TLS, and the like.

Agricultural intelligence computer system 130 is programmed or configured to receive field data 106 from field manager computing device 104, external data 110 from external data server computer 108, and sensor data from remote sensor 112. Agricultural intelligence computer system 130 may be further configured to host, use or execute one or more computer programs, other software elements, digitally programmed logic such as FPGAs or ASICs, or any combination thereof to perform translation and storage of data values, construction of digital models of one or more crops on one or more fields, generation of recommendations and notifications, and generation and sending of scripts to application controller 114, in the manner described further in other sections of this disclosure.

In an embodiment, agricultural intelligence computer system 130 is programmed with or comprises a communication layer 132, presentation layer 134, data management layer 140, hardware/virtualization layer 150, and model and field data repository 160. “Layer,” in this context, refers to any combination of electronic digital interface circuits, microcontrollers, firmware such as drivers, and/or computer programs or other software elements.

Communication layer 132 may be programmed or configured to perform input/output interfacing functions including sending requests to field manager computing device 104, external data server computer 108, and remote sensor 112 for field data, external data, and sensor data respectively. Communication layer 132 may be programmed or configured to send the received data to model and field data repository 160 to be stored as field data 106.

In some embodiments, agricultural intelligence computer system 130 is programmed with or comprises code instructions 180. Code instructions 180 may include one or more sets of programming code instructions. For example, code instructions 180 may include model execution instructions 137 which, when executed by one or more processors, cause the processors to perform receiving, over a computer network, electronic digital data and using the data to generate data models. Code instructions 180 may also include model history instructions 138 which, when executed, cause storing the history instructions. Furthermore, code instructions 180 may include model query instructions 139 which, when executed by the processors, cause handling and parsing the model queries.

Presentation layer 134 may be programmed or configured to generate a graphical user interface (GUI) to be displayed on field manager computing device 104, cab computer 115 or other computers that are coupled to the system 130 through the network 109. The GUI may comprise controls for inputting data to be sent to agricultural intelligence computer system 130, generating requests for models and/or recommendations, and/or displaying recommendations, notifications, models, and other field data.

Data management layer 140 may be programmed or configured to manage read operations and write operations involving the repository 160 and other functional elements of the system, including queries and result sets communicated between the functional elements of the system and the repository. Examples of data management layer 140 include JDBC, SQL server interface code, and/or HADOOP interface code, among others. Repository 160 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, and any other structured collection of records or data that is stored in a computer system. Examples of RDBMS include, but are not limited to, ORACLE®, MYSQL, IBM® DB2, MICROSOFT® SQL SERVER, SYBASE®, and POSTGRESQL databases. However, any database may be used that enables the systems and methods described herein.

When field data 106 is not provided directly to the agricultural intelligence computer system via one or more agricultural machines or agricultural machine devices that interacts with the agricultural intelligence computer system, the user may be prompted via one or more user interfaces on the user device (served by the agricultural intelligence computer system) to input such information. In an example embodiment, the user may specify identification data by accessing a map on the user device (served by the agricultural intelligence computer system) and selecting specific CLUs that have been graphically shown on the map. In an alternative embodiment, the user 102 may specify identification data by accessing a map on the user device (served by the agricultural intelligence computer system 130) and drawing boundaries of the field over the map. Such CLU selection or map drawings represent geographic identifiers. In alternative embodiments, the user may specify identification data by accessing field identification data (provided as shape files or in a similar format) from the U.S. Department of Agriculture Farm Service Agency or other source via the user device and providing such field identification data to the agricultural intelligence computer system.

In an example embodiment, the agricultural intelligence computer system 130 is programmed to generate and cause displaying a graphical user interface comprising a data manager for data input. After one or more fields have been identified using the methods described above, the data manager may provide one or more graphical user interface widgets which when selected can identify changes to the field, soil, crops, tillage, or nutrient practices. The data manager may include a timeline view, a spreadsheet view, and/or one or more editable programs.

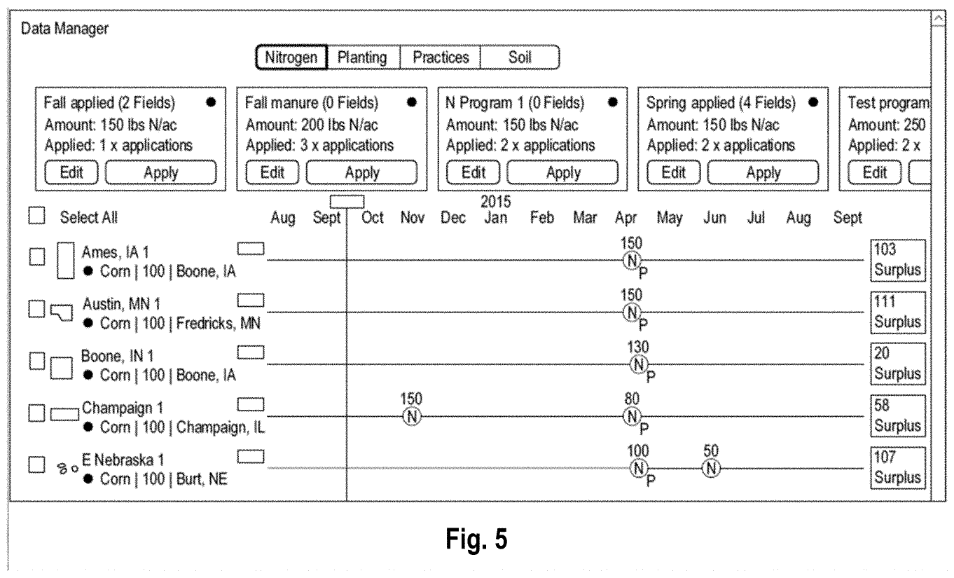

FIG. 5 depicts an example embodiment of a timeline view for data entry. Using the display depicted in FIG. 5, a user computer can input a selection of a particular field and a particular date for the addition of an event. Events depicted at the top of the timeline include Nitrogen, Planting, Practices, and Soil. To add a nitrogen application event, a user computer may provide input to select the nitrogen tab. The user computer may then select a location on the timeline for a particular field in order to indicate an application of nitrogen on the selected field. In response to receiving a selection of a location on the timeline for a particular field, the data manager may display a data entry overlay, allowing the user computer to input data pertaining to nitrogen applications, planting procedures, soil application, tillage procedures, irrigation practices, or other information relating to the particular field. For example, if a user computer selects a portion of the timeline and indicates an application of nitrogen, then the data entry overlay may include fields for inputting an amount of nitrogen applied, a date of application, a type of fertilizer used, and any other information related to the application of nitrogen.

In an embodiment, the data manager provides an interface for creating one or more programs. “Program,” in this context, refers to a set of data pertaining to nitrogen applications, planting procedures, soil application, tillage procedures, irrigation practices, or other information that may be related to one or more fields, and that can be stored in digital data storage for reuse as a set in other operations. After a program has been created, it may be conceptually applied to one or more fields and references to the program may be stored in digital storage in association with data identifying the fields. Thus, instead of manually entering identical data relating to the same nitrogen applications for multiple different fields, a user computer may create a program that indicates a particular application of nitrogen and then apply the program to multiple different fields. For example, in the timeline view of FIG. 5, the top two timelines have the “Fall applied” program selected, which includes an application of 150 lbs. N/ac in early April. The data manager may provide an interface for editing a program. In an embodiment, when a particular program is edited, each field that has selected the particular program is edited. For example, in FIG. 5, if the “Fall applied” program is edited to reduce the application of nitrogen to 130 lbs. N/ac, the top two fields may be updated with a reduced application of nitrogen based on the edited program.

In an embodiment, in response to receiving edits to a field that has a program selected, the data manager removes the correspondence of the field to the selected program. For example, if a nitrogen application is added to the top field in FIG. 5, the interface may update to indicate that the “Fall applied” program is no longer being applied to the top field. While the nitrogen application in early April may remain, updates to the “Fall applied” program would not alter the April application of nitrogen.

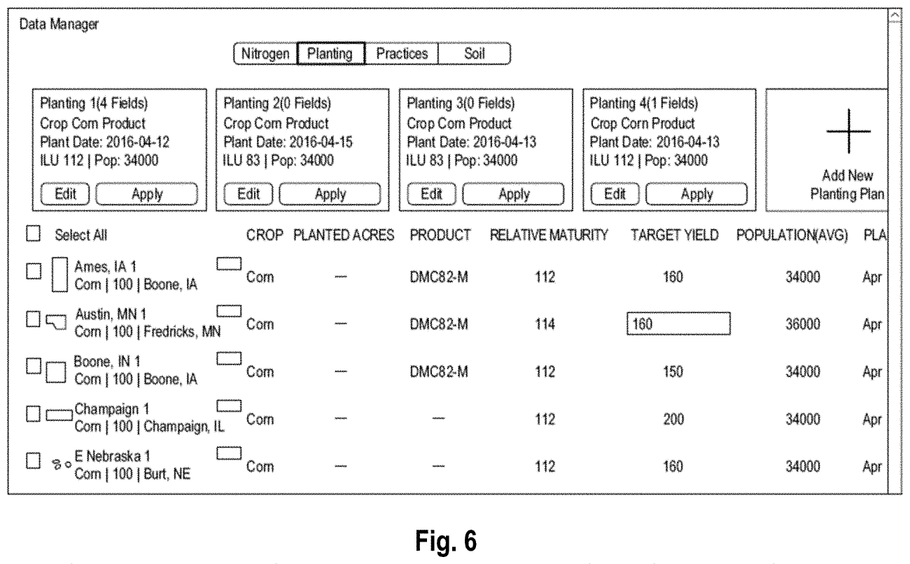

FIG. 6 depicts an example embodiment of a spreadsheet view for data entry. Using the display depicted in FIG. 6, a user can create and edit information for one or more fields. The data manager may include spreadsheets for inputting information with respect to Nitrogen, Planting, Practices, and Soil as depicted in FIG. 6. To edit a particular entry, a user computer may select the particular entry in the spreadsheet and update the values. For example, FIG. 6 depicts an in-progress update to a target yield value for the second field. Additionally, a user computer may select one or more fields in order to apply one or more programs. In response to receiving a selection of a program for a particular field, the data manager may automatically complete the entries for the particular field based on the selected program. As with the timeline view, the data manager may update the entries for each field associated with a particular program in response to receiving an update to the program. Additionally, the data manager may remove the correspondence of the selected program to the field in response to receiving an edit to one of the entries for the field.

In an embodiment, model and field data is stored in model and field data repository 160. Model data comprises data models created for one or more fields. For example, a crop model may include a digitally constructed model of the development of a crop on one or more fields. “Model” in this context refers to an electronic digitally stored set of executable instructions and data values, associated with one another, which are capable of receiving and responding to a programmatic or other digital call, invocation, or request for resolution based upon specified input values, to yield one or more stored output values that can serve as the basis of computer-implemented recommendations, output data displays, or machine control, among other things.

Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model data may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

In one embodiment, each of the relative yield modeling instructions 136 and total yield computation instructions 138 comprises a set of one or more pages of main memory, such as RAM, in the agricultural intelligence computer system 130 into which executable instructions have been loaded and which when executed cause the agricultural intelligence computing system to perform the functions or operations that are described herein with reference to those modules. For example, the relative yield modeling instructions 136 may comprise executable instructions loaded into a set of pages in RAM that contain instructions which when executed cause performing the relative yield modeling functions that are described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, each of the relative yield modeling instructions 136 and total yield computation instructions 138 also may represent one or more files or projects of source code that are digitally stored in a mass storage device such as non-volatile RAM or disk storage, in the agricultural intelligence computer system 130 or a separate repository system, which when compiled or interpreted cause generating executable instructions which when executed cause the agricultural intelligence computing system to perform the functions or operations that are described herein with reference to those modules. In other words, the drawing figure may represent the manner in which programmers or software developers organize and arrange source code for later compilation into an executable, or interpretation into bytecode or the equivalent, for execution by the agricultural intelligence computer system 130. The executable instructions in memory, or the stored source code, specified in this paragraph are examples of “modules” as that term is used in this disclosure.

Relative yield modeling instructions 136 generally represent digitally programmed instructions which, when executed by one or more processors of agricultural intelligence computer system 130 cause agricultural intelligence computer system 130 to perform translation and storage of data values and construction of digital models of relative crop yield based on nitrate values. Total yield computation instructions 138 generally represent digitally programmed instructions which, when executed by one or more processors of agricultural intelligence computer system 130 cause agricultural intelligence computer system 130 to perform translation and storage of data values, construction of digital models of total crop yield, and computation of total crop yield based, at least in part, on the relative crop yield.

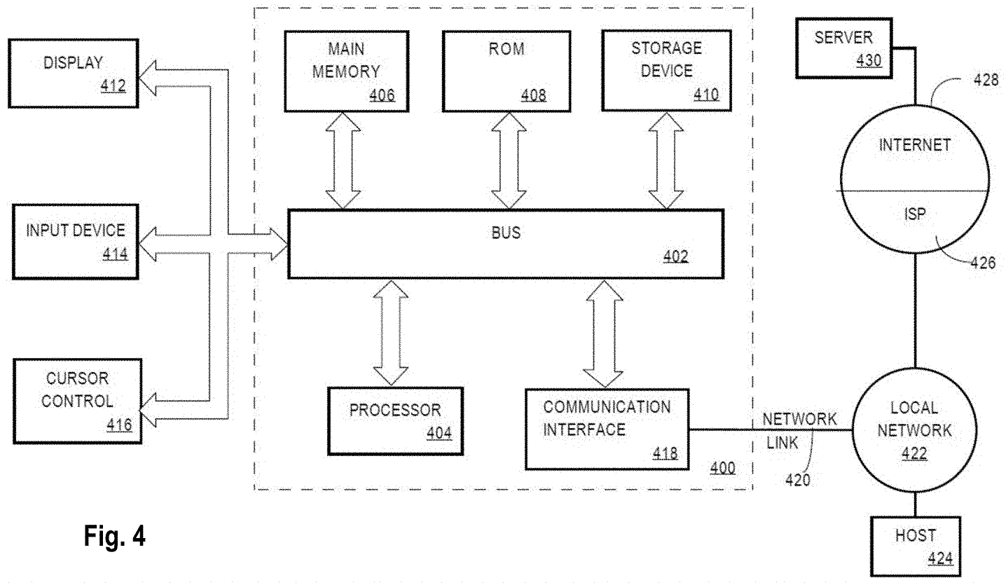

Hardware/virtualization layer 150 comprises one or more central processing units (CPUs), memory controllers, and other devices, components, or elements of a computer system such as volatile or non-volatile memory, non-volatile storage such as disk, and I/O devices or interfaces as illustrated and described, for example, in connection with FIG. 4. The layer 150 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices 104 associated with different users. Further, the system 130 and/or external data server computer 108 may be implemented using two or more processors, cores, clusters, or instances of physical machines or virtual machines, configured in a discrete location or co-located with other elements in a datacenter, shared computing facility or cloud computing facility.

2.2. Application Program Overview

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for inventions and disclosures of this type.

In an embodiment, user 102 interacts with agricultural intelligence computer system 130 using field manager computing device 104 configured with an operating system and one or more application programs or apps; the field manager computing device 104 also may interoperate with the agricultural intelligence computer system independently and automatically under program control or logical control and direct user interaction is not always required. Field manager computing device 104 broadly represents one or more smartphones, PDAs, tablet computing devices, laptop computers, desktop computers, workstations, or any other computing devices capable of transmitting and receiving information and performing the functions described herein. Field manager computing device 104 may communicate via a network using a mobile application stored on field manager computing device 104, and in some embodiments, the device may be coupled using a cable 113 or connector to the sensor 112 and/or controller 114. A particular user 102 may own, operate or possess and use, in connection with system 130, more than one field manager computing device 104 at a time.

The mobile application may provide client-side functionality, via the network to one or more mobile computing devices. In an example embodiment, field manager computing device 104 may access the mobile application via a web browser or a local client application or app. Field manager computing device 104 may transmit data to, and receive data from, one or more front-end servers, using web-based protocols or formats such as HTTP, XML, and/or JSON, or app-specific protocols. In an example embodiment, the data may take the form of requests and user information input, such as field data, into the mobile computing device. In some embodiments, the mobile application interacts with location tracking hardware and software on field manager computing device 104 which determines the location of field manager computing device 104 using standard tracking techniques such as multilateration of radio signals, the global positioning system (GPS), Wi-Fi positioning systems, or other methods of mobile positioning. In some cases, location data or other data associated with the device 104, user 102, and/or user account(s) may be obtained by queries to an operating system of the device or by requesting an app on the device to obtain data from the operating system.

In an embodiment, field manager computing device 104 sends field data 106 to agricultural intelligence computer system 130 comprising or including, but not limited to, data values representing one or more of: a geographical location of the one or more fields, tillage information for the one or more fields, crops planted in the one or more fields, and soil data extracted from the one or more fields. Field manager computing device 104 may send field data 106 in response to user input from user 102 specifying the data values for the one or more fields. Additionally, field manager computing device 104 may automatically send field data 106 when one or more of the data values becomes available to field manager computing device 104. For example, field manager computing device 104 may be communicatively coupled to remote sensor 112 and/or application controller 114. In response to receiving data indicating that application controller 114 released water onto the one or more fields, field manager computing device 104 may send field data 106 to agricultural intelligence computer system 130 indicating that water was released on the one or more fields. Field data 106 identified in this disclosure may be input and communicated using electronic digital data that is communicated between computing devices using parameterized URLs over HTTP, or another suitable communication or messaging protocol.

A commercial example of the mobile application is CLIMATE FIELDVIEW, commercially available from The Climate Corporation, San Francisco, Calif. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

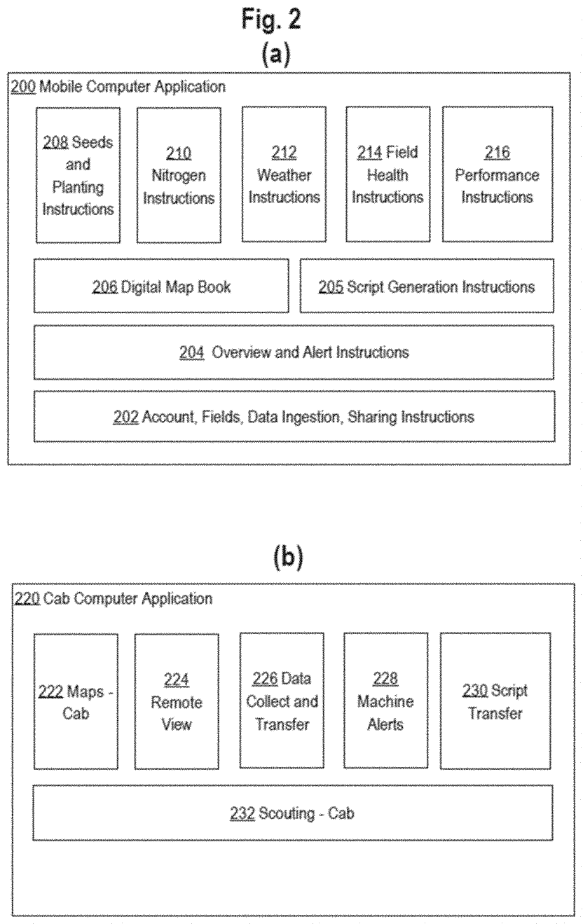

FIG. 2 depicts two views of an example logical organization of sets of instructions in main memory when an example mobile application is loaded for execution. In FIG. 2, each named element represents a region of one or more pages of RAM or other main memory, or one or more blocks of disk storage or other non-volatile storage, and the programmed instructions within those regions. In one embodiment, in view (a), a mobile computer application 200 comprises account-fields-data ingestion-sharing instructions 202, overview and alert instructions 204, digital map book instructions 206, seeds and planting instructions 208, nitrogen instructions 210, weather instructions 212, field health instructions 214, and performance instructions 216.

In one embodiment, a mobile computer application 200 comprises account-fields-data ingestion-sharing instructions 202 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 200 comprises a data inbox. In response to receiving a selection of the data inbox, the mobile computer application 200 may display a graphical user interface for manually uploading data files and importing uploaded files to a data manager.

In one embodiment, digital map book instructions 206 comprise field map data layers stored in device memory and are programmed with data visualization tools and geospatial field notes. This provides growers with convenient information close at hand for reference, logging and visual insights into field performance. In one embodiment, overview and alert instructions 204 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 208 are programmed to provide tools for seed selection, hybrid placement, and script creation, including variable rate (VR) script creation, based upon scientific models and empirical data. This enables growers to maximize yield or return on investment through optimized seed purchase, placement and population.

In one embodiment, script generation instructions 205 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, mobile computer application 200 may display one or more fields broken into soil zones along with a panel identifying each soil zone and a soil name, texture, and drainage for each zone. Mobile computer application 200 may also display tools for editing or creating such, such as graphical tools for drawing soil zones over a map of one or more fields. Planting procedures may be applied to all soil zones or different planting procedures may be applied to different subsets of soil zones. When a script is created, mobile computer application 200 may make the script available for download in a format readable by an application controller, such as an archived or compressed format. Additionally, and/or alternatively, a script may be sent directly to cab computer 115 from mobile computer application 200 and/or uploaded to one or more data servers and stored for further use. In one embodiment, nitrogen instructions 210 are programmed to provide tools to inform nitrogen decisions by visualizing the availability of nitrogen to crops. This enables growers to maximize yield or return on investment through optimized nitrogen application during the season. Example programmed functions include displaying images such as SSURGO images to enable drawing of application zones and/or images generated from subfield soil data, such as data obtained from sensors, at a high spatial resolution (as fine as 10 meters or smaller because of their proximity to the soil); upload of existing grower-defined zones; providing an application graph and/or a map to enable tuning application(s) of nitrogen across multiple zones; output of scripts to drive machinery; tools for mass data entry and adjustment; and/or maps for data visualization, among others. “Mass data entry,” in this context, may mean entering data once and then applying the same data to multiple fields that have been defined in the system; example data may include nitrogen application data that is the same for many fields of the same grower, but such mass data entry applies to the entry of any type of field data into the mobile computer application 200. For example, nitrogen instructions 210 may be programmed to accept definitions of nitrogen planting and practices programs and to accept user input specifying to apply those programs across multiple fields. “Nitrogen planting programs,” in this context, refers to a stored, named set of data that associates: a name, color code or other identifier, one or more dates of application, types of material or product for each of the dates and amounts, method of application or incorporation such as injected or knifed in, and/or amounts or rates of application for each of the dates, crop or hybrid that is the subject of the application, among others.

Nitrogen practices programs in this context refers to a stored, named set of data that associates: a practices name; a previous crop; a tillage system; a date of primarily tillage; one or more previous tillage systems that were used; one or more indicators of application type, such as manure, that were used. Nitrogen instructions 210 also may be programmed to generate and cause displaying a nitrogen graph, which indicates projections of plant use of the specified nitrogen and whether a surplus or shortfall is predicted; in some embodiments, different color indicators may signal a magnitude of surplus or magnitude of shortfall. In one embodiment, a nitrogen graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each nitrogen application and amount at points correlated to month names; and numeric and/or colored indicators of surplus or shortfall, in which color indicates magnitude.

In one embodiment, the nitrogen graph may include one or more user input features, such as dials or slider bars, to dynamically change the nitrogen planting and practices programs so that a user may optimize his nitrogen graph. The user may then use his optimized nitrogen graph and the related nitrogen planting and practices programs to implement one or more scripts, including variable rate (VR) fertility scripts. Nitrogen instructions 210 also may be programmed to generate and cause displaying a nitrogen map, which indicates projections of plant use of the specified nitrogen and whether a surplus or shortfall is predicted; in some embodiments, different color indicators may signal a magnitude of surplus or magnitude of shortfall.

The nitrogen map may display projections of plant use of the specified nitrogen and whether a surplus or shortfall is predicted for different times in the past and the future (such as daily, weekly, monthly, or yearly) using numeric and/or colored indicators of surplus or shortfall, in which color indicates magnitude. In one embodiment, the nitrogen map may include one or more user input features, such as dials or slider bars, to dynamically change the nitrogen planting and practices programs so that a user may optimize his nitrogen map, such as to obtain a preferred amount of surplus to shortfall. The user may then use his optimized nitrogen map and the related nitrogen planting and practices programs to implement one or more scripts, including variable rate (VR) fertility scripts. In other embodiments, similar instructions to the nitrogen instructions 210 could be used for application of other nutrients (such as phosphorus and potassium), applications of pesticide, and irrigation programs.

In one embodiment, weather instructions 212 are programmed to provide field-specific recent weather data and forecasted weather information. This enables growers to save time and have an efficient integrated display with respect to daily operational decisions.

In one embodiment, field health instructions 214 are programmed to provide timely remote sensing images highlighting in-season crop variation and potential concerns. Example programmed functions include cloud checking, to identify possible clouds or cloud shadows; determining nitrogen indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 216 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 216 may be programmed to communicate via the network(s) 109 to back-end analytics programs executed at agricultural intelligence computer system 130 and/or external data server computer 108 and configured to analyze metrics such as yield, hybrid, population, SSURGO, soil tests, or elevation, among others. Programmed reports and analysis may include yield variability analysis, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of cab computer 115. For example, referring now to view (b) of FIG. 2, in one embodiment a cab computer application 220 may comprise maps-cab instructions 222, remote view instructions 224, data collect and transfer instructions 226, machine alerts instructions 228, script transfer instructions 230, and scouting-cab instructions 232. The code base for the instructions of view (b) may be the same as for view (a) and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 222 may be programmed to provide map views of fields, farms or regions that are useful in directing machine operation. The remote view instructions 224 may be programmed to turn on, manage, and provide views of machine activity in real-time or near real-time to other computing devices connected to the system 130 via wireless networks, wired connectors or adapters, and the like. The data collect and transfer instructions 226 may be programmed to turn on, manage, and provide transfer of data collected at machine sensors and controllers to the system 130 via wireless networks, wired connectors or adapters, and the like. The machine alerts instructions 228 may be programmed to detect issues with operations of the machine or tools that are associated with the cab and generate operator alerts. The script transfer instructions 230 may be configured to transfer in scripts of instructions that are configured to direct machine operations or the collection of data. The scouting-cab instructions 230 may be programmed to display location-based alerts and information received from the system 130 based on the location of the agricultural apparatus 111 or sensors 112 in the field and ingest, manage, and provide transfer of location-based scouting observations to the system 130 based on the location of the agricultural apparatus 111 or sensors 112 in the field.

2.3. Data Ingest to the Computer System

In an embodiment, external data server computer 108 stores external data 110, including soil data representing soil composition for the one or more fields and weather data representing temperature and precipitation on the one or more fields. The weather data may include past and present weather data as well as forecasts for future weather data. In an embodiment, external data server computer 108 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil.

In an embodiment, remote sensor 112 comprises one or more sensors that are programmed or configured to produce one or more observations. Remote sensor 112 may be aerial sensors, such as satellites, vehicle sensors, planting equipment sensors, tillage sensors, fertilizer or insecticide application sensors, harvester sensors, and any other implement capable of receiving data from one or more fields. In an embodiment, application controller 114 is programmed or configured to receive instructions from agricultural intelligence computer system 130. Application controller 114 may also be programmed or configured to control an operating parameter of an agricultural vehicle or implement. For example, an application controller may be programmed or configured to control an operating parameter of a vehicle, such as a tractor, planting equipment, tillage equipment, fertilizer or insecticide equipment, harvester equipment, or other farm implements such as a water valve. Other embodiments may use any combination of sensors and controllers, of which the following are merely selected examples.

The system 130 may obtain or ingest data under user 102 control, on a mass basis from a large number of growers who have contributed data to a shared database system. This form of obtaining data may be termed “manual data ingest” as one or more user-controlled computer operations are requested or triggered to obtain data for use by the system 130. As an example, the CLIMATE FIELDVIEW application, commercially available from The Climate Corporation, San Francisco, Calif., may be operated to export data to system 130 for storing in the repository 160.

For example, seed monitor systems can both control planter apparatus components and obtain planting data, including signals from seed sensors via a signal harness that comprises a CAN backbone and point-to-point connections for registration and/or diagnostics. Seed monitor systems can be programmed or configured to display seed spacing, population and other information to the user via the cab computer 115 or other devices within the system 130. Examples are disclosed in U.S. Pat. No. 8,738,243 and U.S. Pat. Pub. 20150094916, and the present disclosure assumes knowledge of those other patent disclosures.

Likewise, yield monitor systems may contain yield sensors for harvester apparatus that send yield measurement data to the cab computer 115 or other devices within the system 130. Yield monitor systems may utilize one or more remote sensors 112 to obtain grain moisture measurements in a combine or other harvester and transmit these measurements to the user via the cab computer 115 or other devices within the system 130.

In an embodiment, examples of sensors 112 that may be used with any moving vehicle or apparatus of the type described elsewhere herein include kinematic sensors and position sensors. Kinematic sensors may comprise any of speed sensors such as radar or wheel speed sensors, accelerometers, or gyros. Position sensors may comprise GPS receivers or transceivers, or Wi-Fi-based position or mapping apps that are programmed to determine location based upon nearby Wi-Fi hotspots, among others.

In an embodiment, examples of sensors 112 that may be used with tractors or other moving vehicles include engine speed sensors, fuel consumption sensors, area counters or distance counters that interact with GPS or radar signals, PTO (power take-off) speed sensors, tractor hydraulics sensors configured to detect hydraulics parameters such as pressure or flow, and/or and hydraulic pump speed, wheel speed sensors or wheel slippage sensors. In an embodiment, examples of controllers 114 that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors 112 that may be used with seed planting equipment such as planters, drills, or air seeders include seed sensors, which may be optical, electromagnetic, or impact sensors; downforce sensors such as load pins, load cells, pressure sensors; soil property sensors such as reflectivity sensors, moisture sensors, electrical conductivity sensors, optical residue sensors, or temperature sensors; component operating criteria sensors such as planting depth sensors, downforce cylinder pressure sensors, seed disc speed sensors, seed drive motor encoders, seed conveyor system speed sensors, or vacuum level sensors; or pesticide application sensors such as optical or other electromagnetic sensors, or impact sensors. In an embodiment, examples of controllers 114 that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors 112 that may be used with tillage equipment include position sensors for tools such as shanks or discs; tool position sensors for such tools that are configured to detect depth, gang angle, or lateral spacing; downforce sensors; or draft force sensors. In an embodiment, examples of controllers 114 that may be used with tillage equipment include downforce controllers or tool position controllers, such as controllers configured to control tool depth, gang angle, or lateral spacing.

In an embodiment, examples of sensors 112 that may be used in relation to apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors such as accelerometers disposed on sprayer booms. In an embodiment, examples of controllers 114 that may be used with such apparatus include pump speed controllers; valve controllers that are programmed to control pressure, flow, direction, PWM and the like; or position actuators, such as for boom height, subsoiler depth, or boom position.

In an embodiment, examples of sensors 112 that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers 114 that may be used with harvesters include header operating criteria controllers for elements such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors 112 that may be used with grain carts include weight sensors, or sensors for auger position, operation, or speed. In an embodiment, examples of controllers 114 that may be used with grain carts include controllers for auger position, operation, or speed.

In an embodiment, examples of sensors 112 and controllers 114 may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus. Such controllers may include guidance or motor control apparatus, control surface controllers, camera controllers, or controllers programmed to turn on, operate, obtain data from, manage and configure any of the foregoing sensors. Examples are disclosed in U.S. patent application Ser. No. 14/831,165 and the present disclosure assumes knowledge of that other patent disclosure.

In an embodiment, sensors 112 and controllers 114 may be affixed to soil sampling and measurement apparatus that is configured or programmed to sample soil and perform soil chemistry tests, soil moisture tests, and other tests pertaining to soil. For example, the apparatus disclosed in U.S. Pat. No. 8,767,194 and U.S. Pat. No. 8,712,148 may be used, and the present disclosure assumes knowledge of those patent disclosures.

2.4. Process Overview—Agronomic Model Training

In an embodiment, the agricultural intelligence computer system 130 is programmed or configured to create an agronomic model. In this context, an agronomic model is a data structure in memory of the agricultural intelligence computer system 130 that comprises field data 106, such as identification data and harvest data for one or more fields. The agronomic model may also comprise calculated agronomic properties which describe either conditions which may affect the growth of one or more crops on a field, or properties of the one or more crops, or both. Additionally, an agronomic model may comprise recommendations based on agronomic factors such as crop recommendations, irrigation recommendations, planting recommendations, and harvesting recommendations. The agronomic factors may also be used to estimate one or more crop related results, such as agronomic yield. The agronomic yield of a crop is an estimate of the quantity of the crop that is produced, or in some examples the revenue or profit obtained from the produced crop.

In an embodiment, the agricultural intelligence computer system 130 may use a preconfigured agronomic model to calculate agronomic properties related to currently received location and crop information for one or more fields. The preconfigured agronomic model is based upon previously processed field data, including but not limited to, identification data, harvest data, fertilizer data, and weather data. The preconfigured agronomic model may have been cross validated to ensure accuracy of the model. Cross validation may include comparison to ground truthing that compares predicted results with actual results on a field, such as a comparison of precipitation estimate with a rain gauge at the same location or an estimate of nitrogen content with a soil sample measurement.

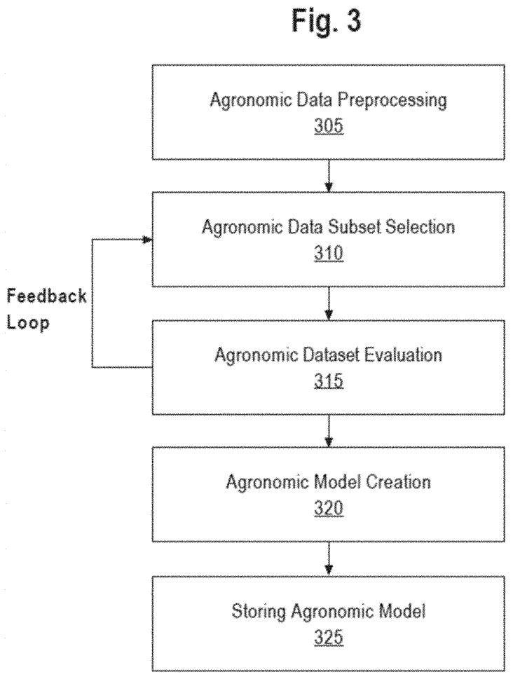

FIG. 3 depicts a programmed process by which the agricultural intelligence computer system generates one or more preconfigured agronomic models using field data provided by one or more data sources. FIG. 3 may serve as an algorithm or instructions for programming the functional elements of the agricultural intelligence computer system 130 to perform the operations that are now described.

At block 305, the agricultural intelligence computer system 130 is configured or programmed to implement agronomic data preprocessing of field data received from one or more data sources. The field data received from one or more data sources may be preprocessed for the purpose of removing noise and distorting effects within the agronomic data including measured outliers that would bias received field data values. Embodiments of agronomic data preprocessing may include, but are not limited to, removing data values commonly associated with outlier data values, specific measured data points that are known to unnecessarily skew other data values, data smoothing techniques used to remove or reduce additive or multiplicative effects from noise, and other filtering or data derivation techniques used to provide clear distinctions between positive and negative data inputs.

At block 310, the agricultural intelligence computer system 130 is configured or programmed to perform data subset selection using the preprocessed field data in order to identify datasets useful for initial agronomic model generation. The agricultural intelligence computer system 130 may implement data subset selection techniques including, but not limited to, a genetic algorithm method, an all subset models method, a sequential search method, a stepwise regression method, a particle swarm optimization method, and an ant colony optimization method. For example, a genetic algorithm selection technique uses an adaptive heuristic search algorithm, based on evolutionary principles of natural selection and genetics, to determine and evaluate datasets within the preprocessed agronomic data.

At block 315, the agricultural intelligence computer system 130 is configured or programmed to implement field dataset evaluation. In an embodiment, a specific field dataset is evaluated by creating an agronomic model and using specific quality thresholds for the created agronomic model. Agronomic models may be compared using cross validation techniques including, but not limited to, root mean square error of leave-one-out cross validation (RMSECV), mean absolute error, and mean percentage error. For example, RMSECV can cross validate agronomic models by comparing predicted agronomic property values created by the agronomic model against historical agronomic property values collected and analyzed. In an embodiment, the agronomic dataset evaluation logic is used as a feedback loop where agronomic datasets that do not meet configured quality thresholds are used during future data subset selection steps (block 310).

At block 320, the agricultural intelligence computer system 130 is configured or programmed to implement agronomic model creation based upon the cross validated agronomic datasets. In an embodiment, agronomic model creation may implement multivariate regression techniques to create preconfigured agronomic data models.

At block 325, the agricultural intelligence computer system 130 is configured or programmed to store the preconfigured agronomic data models for future field data evaluation.

2.5. IMplementation Example-Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 4 is a block diagram that depicts a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated-services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

3. Scalable Geospatial Platform for an Integrated Data Synthesis and AI Based Exploration

3.1. Scalable Geospatial Platform

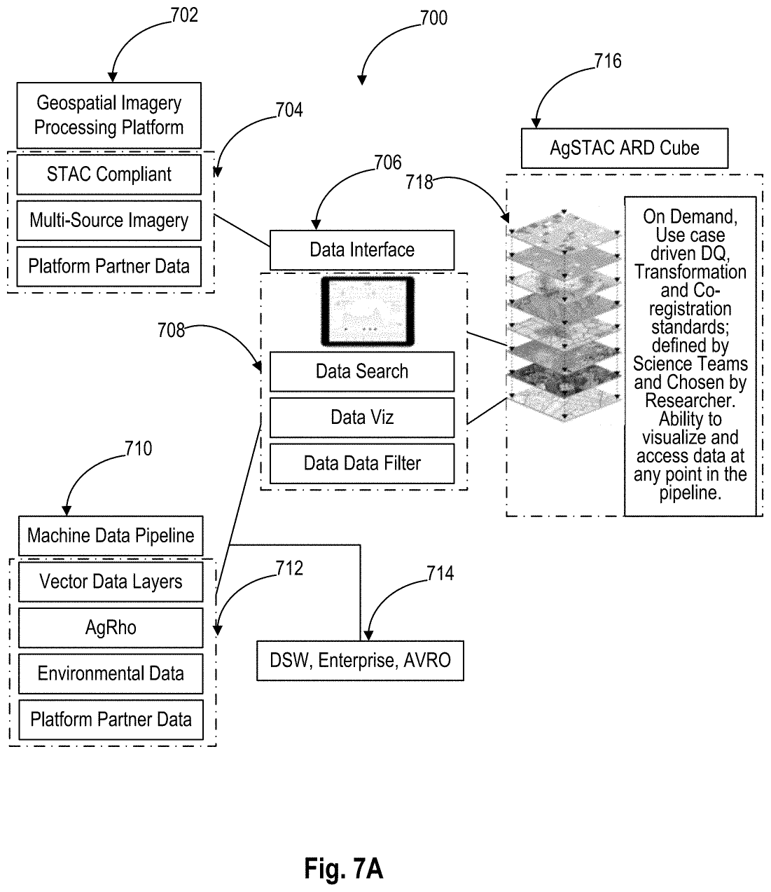

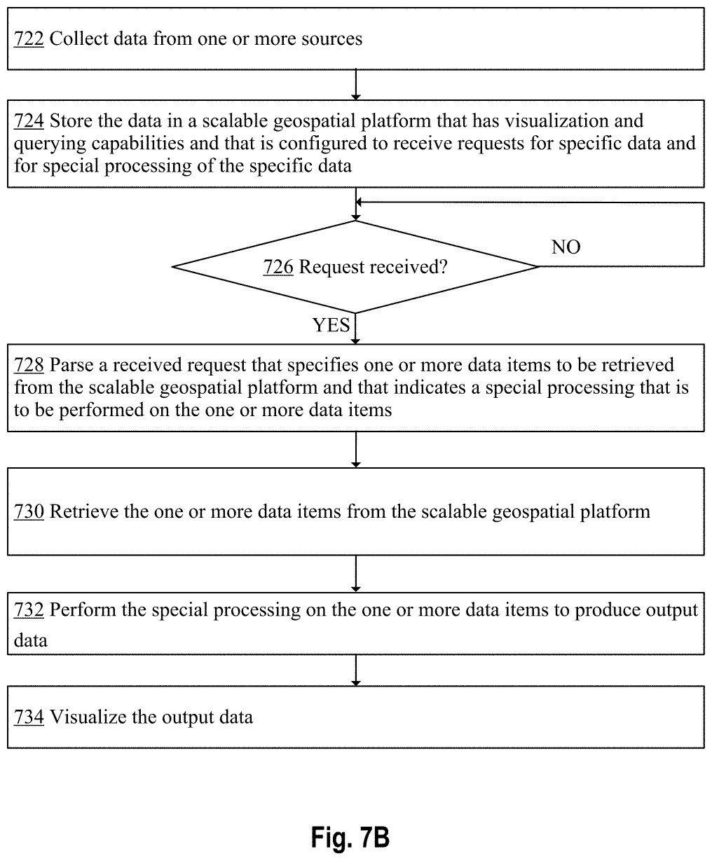

FIG. 7A depicts an example configuration of a scalable geospatial platform 700. In some embodiments, scalable geospatial platform 700 is implemented in one or more agricultural computer systems, and comprises components 702, 704, 706, 708, 710, 712, 714, and 716. Each of components 702, 704, 706, 708, 710, 712, 714, and 716 may include one or more subcomponents. The types of the subcomponents depend on the implementation. Examples of subcomponents are shown and described in FIG. 7A. Generally, subcomponents 704, 712, and 714 may be implemented as internal databases containing the agronomic and environmental data.

One of the components is referred to as an Agricultural Spatial Temporal Asset Catalogue (AgSTAC) 716. AgSTAC 716 may be configured to generate an on-demand ARD dataset selected in a data interface and ingested from a machine data pipeline and a geospatial imagery processing platform. The data interface contains a visualization interface and it aims to be an intuitive browser-based application that enables the advancement of data discovery.

A geospatial imagery processing platform 710 is a system that delivers raster images from remote sensing sources. Since the unique spatial data layers 712 of the datasets may be stored in the agricultural computer systems in various formats, AgSTAC 716 may be configured to perform an on-demand rendering of the data cubes of the datasets in order to limit the resulting data, and thus to avoid redundancy in data storage.

In some embodiments, two principal data types used by the scalable geospatial platform include a geospatial vector (including point data) and geospatial raster data. Representatives of these types correspond to the environmental and machine data for the vector type, and imagery (typically multispectral data) for the raster type. Maintaining these datasets in their native formats and resolutions before applying a suite of filtering and quality control (qc) processes is critical to maintaining the spatial and attribute fidelity of the information as well as limiting the propagation of errors resulting from unnecessary resampling.

3.2. Example Flow Chart

FIG. 7B depicts an example flow chart of an integrated data synthesis and artificial intelligence based exploration process. In some embodiments, the process is implemented in a scalable geospatial platform that is configured with the capabilities for supporting an integrated data synthesis and artificial intelligence based exploration.

In some embodiments, the scalable geospatial platform is an AgSTAC. The scalable geospatial platform may implement geographical information systems, geospatial data models and formats, geographic coordinate systems and projections, spatial data transformation, rasterization techniques, geospatial algorithms and related software libraries and tools, open geospatial data standards, or future technology trends. Furthermore, the scalable geospatial platform may implement geospatial standards for data processing and predictive modeling at scale.

In step 722, a scalable geospatial platform collects data from one or more sources. The sources may include weather data sources, field data sources, crop data sources, sensors, machines, computer networks, software applications, farmer workers, and others.

In step 724, the scalable geospatial platform stores the data in the platform's storage units. In some embodiments, the scalable geospatial platform stores machine data that contain georeferenced measurements received from sensors of various types mounted on agricultural machines such as combines, planters, sprayers, soil samplers, tractors, irrigation units, and other equipment associated with agronomic activities.

The sensors may provide imagery or raster data that contain georeferenced measurements. The sensors may include passive and active airborne or spaceborne sensors. The machine data may be collected while the agricultural machines are operating in agricultural fields. Operating in the agricultural fields may include precision farming and collecting and analyzing data within the agricultural field.

In some embodiments, the scalable geospatial platform has visualization and querying capabilities and is configured to receive requests for specific data and for special processing of the specific data. The special processing may include, for example, processing and transforming ingested raw machine data into intermediate data types and storing transformed data in different data formats in the scalable geospatial platform.

In step 726, the scalable geospatial platform tests whether a request, which specifies one or more data items to be retrieved from the scalable geospatial platform and which indicates a special processing that is to be performed on the one or more data items, is received.

If the request is received, then the scalable geospatial platform proceeds to perform step 728 in which the platform parses the received request; otherwise, the platform continues testing in step 726.

The special processing to be performed on the one or more data items may include developing artificial intelligence (AI) data models, training the AI data models, validating the AI data models, and/or applying an AI approach to specific data.

In step 730, the scalable geospatial platform retrieves the one or more data items from the scalable geospatial platform. That may include retrieving the data that contain georeferenced measurements received from sensors of various types mounted on agricultural machines such as combines, planters, sprayers, soil samplers, tractors, irrigation units, and other equipment associated with agronomic activities.

In some embodiments, to retrieve the data, the scalable geospatial platform accesses one or more unique spatial data layers stored in one or more storage systems and stored in one or more data formats. The one or more unique special data layers store the data in a plurality of principal data formats, which comprise a geospatial vector (including point data) and a geospatial raster data format. The principal data formats may be used to represent environmental and machine data for vector type, imagery, typically multispectral data, and raster data. The data represented in the principal data formats allow maintaining the on-demand datasets in their native formats and resolutions before applying a suite of filtering processes to the on-demand datasets.

In step 732, the scalable geospatial platform performs the special processing, specified in the request, on the one or more data items to produce output data. The special processing to be performed on the one or more data items may include developing artificial intelligence (AI) data models, training the AI data models, validating the AI data models, and/or applying an AI approach to specific data.

In step 734, the scalable geospatial platform generates, based on the output data, a graphical representation of the output data. Then, based on the graphical representation of the output data, the platform generates a graphical user interface to visualize the output data. This may include generating a visualization of, for example, a generated AI data model, a trained AI data model, a validated AI data model, and/or any other form of visualization of the output data.

4. Machine Data

In some embodiments, machine data contains georeferenced measurements received from various sensors mounted on combines, planters, sprayers, soil samplers, tractors, irrigation units, and other equipment associated with agronomic activities performed in agricultural fields. The machine data may also include the data provided by satellites (i.e., Landsat, RapidEye, Sentinel2, and others), the data provided from handheld devices (i.e., pictures acquired by the handheld devices), images provided by drones, and the like.

High capacity machines have normally treated large agricultural fields in a uniform way. However, since there are many differences within the fields, non-uniform ways may be employed to process the machine data collected from the non-uniform fields to provide the capabilities for precision farming and for effective collecting and analyzing of the machine data.

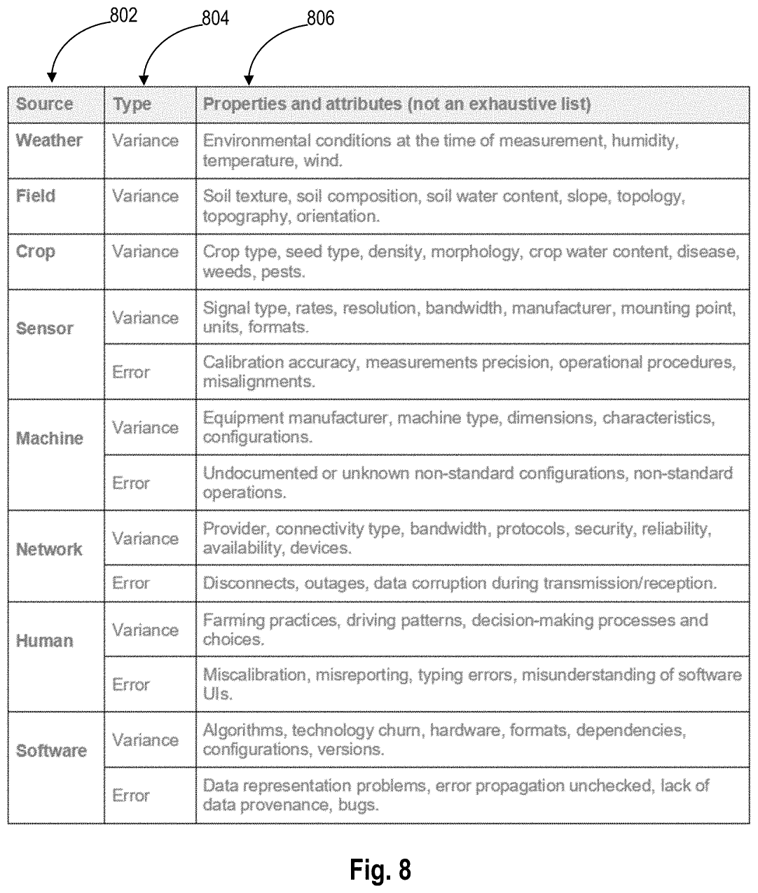

In some embodiments, processing of the machine data at the pipeline level relates to deep-down understanding of the data, and to designing diligent and creative solutions that properly deal, in a scalable and evolvable manner, with the sources of data variance and errors. Examples of non-exhaustive compilations of these are provided in the FIG. 8.

FIG. 8 depicts examples of properties and attributes of machine data. The depicted examples do not form an exhaustive list of all different properties and attributes associated with different types of machine data. The depicted examples, however, are meant to provide a sense of some of the variables and the types of errors that may represent the machine data in various forms. In some embodiments, both legacy and the new machine data pipeline process and transform ingest the raw machine data into data expressed in intermediate data types and store the data in different formats.

In some embodiments, machine data have a plurality of characteristics, including a source 802, a type 804, and properties/attributes 806. In other implementations, the characteristics may be different.

In addition to the sources of variance and errors, the presented approach takes into consideration the limitations and issues related to certain assumptions, chosen representations of the data, chosen representations and modelling of the data, selected solution models, and the algorithms related by the agricultural computer platform. For example, variations within a field can show up in random patterns (as in rain or water content) or in nested patterns (as in topology, texture, soil content, or crop type planted, machine driving patterns). This means that the spatial variations and errors within a field can be correlated or uncorrelated. Equally critical are the temporal and spatial resolutions of the measurements taken by the machine, the collocation and alignment between sensors and between the sensors and the GPS device on the machine, the knowledge of their locations and configurations, the choice of a cell grid or graticule, and a cell size and a cell shape used when adjusting or interpolating, extrapolating, or mapping the measurements to achieve uniformity within a cell in the chosen grid.

The machine data pipeline might or might not re-use the data formats and data stages and algorithms of the current machine data pipeline. For example, as part of the implementation of AgSTAC, the integration of the machine data pipeline, the geospatial imagery processing platform and the data interface may involve some mediation that may be managed by the agricultural science teams.

5. Imagery Data and Systems

Typically, imagery or raster data, contain georeferenced measurements from passive and active airborne or spaceborne sensors. The imagery may include multispectral sensor data, panchromatic optical data, and/or synthetic aperture radar data. Current agricultural intelligent systems usually consume satellite data from various providers and satellite platforms including ESA's Copernicus Mission (the Sentinels), Airbus Spot6, Spot7 and Pleiades, and Planet's Planetscope Legacy and SuperDoves. The system may also consume manned aerial data and unmanned aerial (e.g., drone) data provided and owned by the research teams, customers, and partners.

Usually, a primary purpose of collecting the datasets is to fulfil the needs for in-season monitoring of customer's or enterprise-owned fields in FIELDVIEW. Various back-end systems interact with each other to ingest daily imagery from satellite (and in the future also from drones) providers to produce field-based vegetation index maps and scouting maps that are sent to the end users in a timely fashion (typically, within 24 hours from the image acquisition). This is part of the field health product features offered within FIELDVIEW. The back-end systems are also configured to port the data as auxiliary data to machine learning models and analytical models for forecasting various parameter values, including, for example, yield at the field level.

6. Geospatial Imagery Processing Platform

In some embodiments, a geospatial imagery processing platform system is a scalable, extensible, and globally distributed system that provides an archive and catalog capability of remotely-sensed imagery data. The geospatial imagery processing platform also provides processing functions to fulfill various agricultural business requirements, and the needs of customers and end-users. It offers highly-available scalable services for the acquisition, ingest, processing, and analysis of remotely-sensed data sets.

The geospatial imagery processing platform system may be configured to store all of its data as a Cloud-Optimized Geotiffs (COG) and to use the Spatiotemporal Asset Catalog (STAC) for its catalog/index system. In some implementations, the geospatial imagery processing platform's core geospatial processing engine may be replaced with an improved design that complies with the evolvability and extensibility requirements so that it can efficiently handle future use-cases and future algorithms. Furthermore, the AgSTAC functionality maintains a STAC-friendly framework that is interoperable with the geospatial technology standards already in use.

7. Example Spatial Component

Virtually every operational application in the FIELDVIEW system, the emerging digital farming platform and underlying cloud capabilities heavily relies upon high quality geospatial data to enable key features, both directly and indirectly. In addition, these data serve as a key source for the research scientists as the researchers pursue new predictive agronomic models, assess, and improve data quality, and correlate agronomic events with yield outcomes and remotely sensed data.

In some embodiments, the agricultural computer platform comprises one or more spatial components that meet the growing demand from the agricultural researchers for scalable data transformation, and processing and analysis that can adapt to different levels of spatial aggregation and integration.

Data aggregation refers to the problem of bringing together various data streams at scale, while data integration concerns the challenges of harmonizing diverse (in format, type, spatial reference, spatial units, etc.) spatial datasets. Although the data integration and aggregation challenges are fundamental in their own rights, the presented platform addresses them holistically and simultaneously to provide a satisfactory system that scientists will have no barrier to use.

A new spatial component of the presented data pipeline allows for the large-scale co-registration and transformation of different types of spatially explicit data, while ensuring long-term sustainability and scalability of the proposed solution. The new spatial component enables a scalable geospatial processing environment that allows for development, testing, validation, and deployment of basic geoprocessing functions through advanced machine/deep learning models utilizing both raster and vector data in conjunction.

Furthermore, the new spatial component supports AgSTAC specifications that include workflows, transformation methods, code, documentation, and standards for preparing ARD cubes using machine, environmental, image and weather data. The spatial component may be configured to handle multiple layers of data, including planting data, harvest data, soil data, elevation, image time series, as applied fertility data, seed density data and weather time series. Each of the data layers can have multiple attributes stored in a variety of formats including .dat, .shp, .tif, .nc, .txt and .flt.

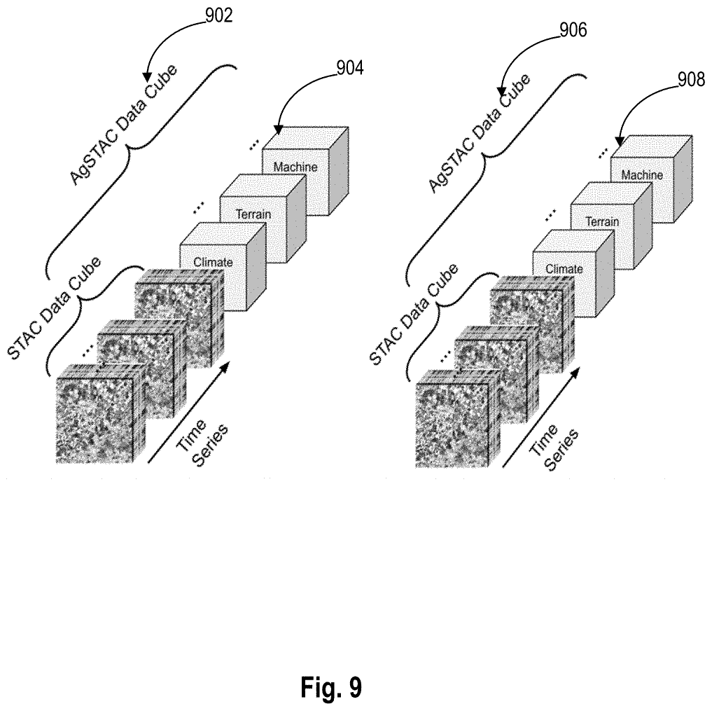

FIG. 9 depicts examples of multiple layers of data. The figure illustrates examples of expanding the existing STAC framework to be more inclusive of the entire data suite necessary for agronomic modeling. The layers include an AgSTAC data cube 902, having cubes 904, etc., and AgSTAC data cube 906, having cubes 908, etc.

The generalized functionality of the new special component revolves around the dimensions of ingestion, query, transformation, output, and modeling from the perspective of end users. A typical workflow of the processing performed by the component includes:
1. Obtain or construct a set of input polygons.
2. Query the system to find layers that intersect input polygons over a defined time frame.
3. Provide a specification to define how the output data should be projected, co-registered and which layers should be returned as features. Additionally, provide blocks of code to transform and aggregate layers at scale on the system.

Output data may be staged or made available in a Deep Learning optimized form, including a user defined multi-column, multi-banded dataset that can be used as input into a distributed training platform (e.g., tensorflow horovod). That data may also be subjected to the additional feature engineering processing before being input into a training module.

8. Example AgSTAC Capabilities

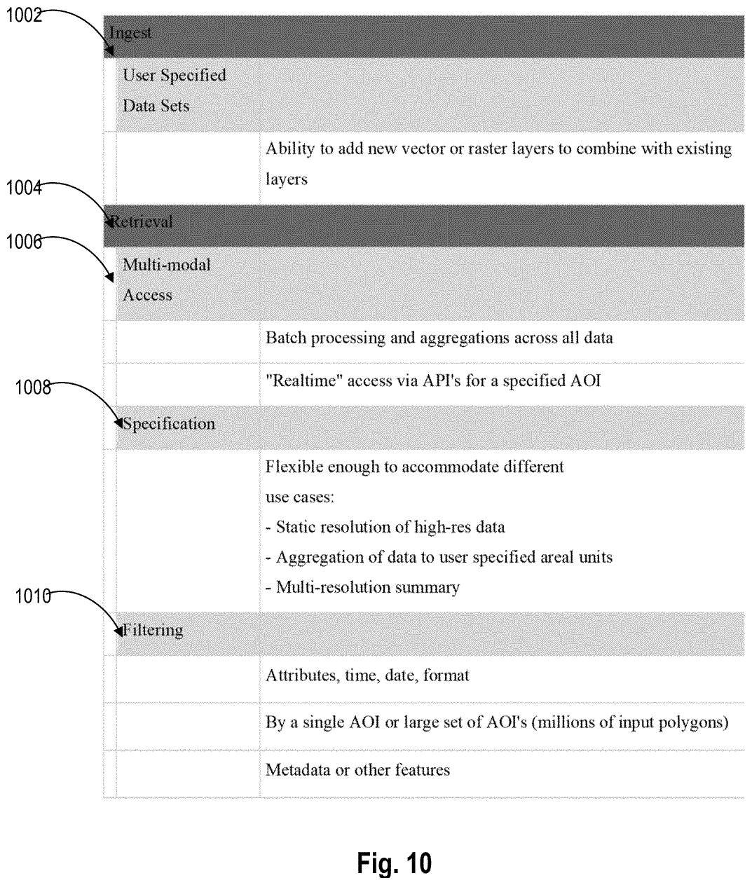

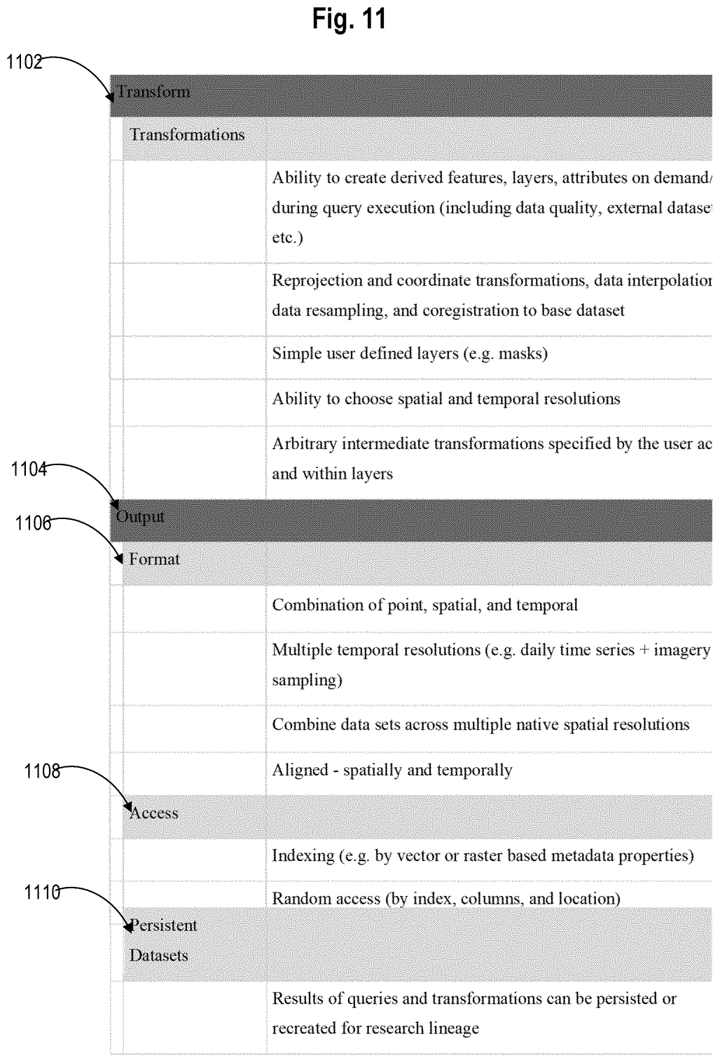

FIG. 10 and FIG. 11 depict examples of AgSTAC capabilities. As shown in FIG. 10, the capabilities may include ingest capabilities 1002 and retrieval capabilities 1004, which may include multi-modal access capabilities 1006, specification capabilities 1008, and filtering capabilities 1010. Furthermore, as shown in FIG. 11, the capabilities may include transform capabilities 1102 and output capabilities 1104, which may include format capabilities 1106, access capabilities 1108, and persistent datasets capabilities 1110. The types and scopes of the capabilities may vary from one implementation to another.

9. Example Geoprocessing Environment

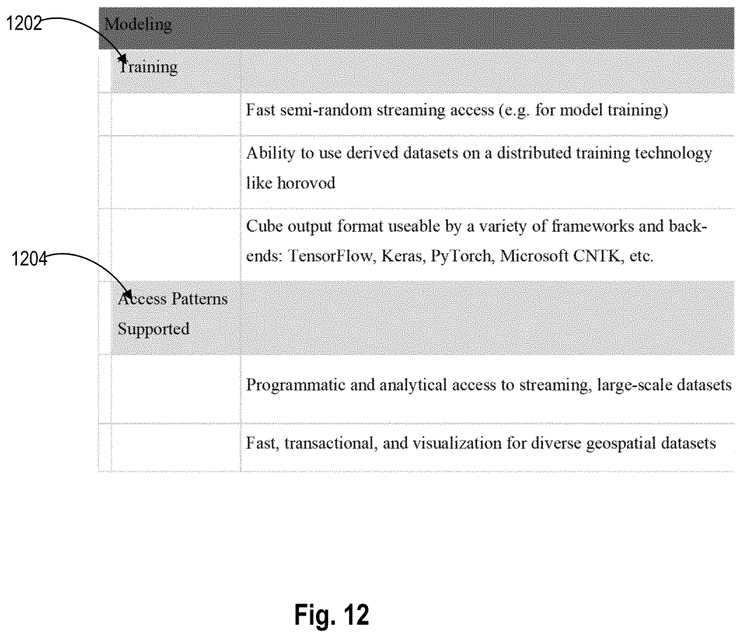

FIG. 12 depicts examples of geoprocessing environments. The example environments are defined in terms of training capabilities 1202 and supported access patterns 1204. Training capabilities 1202 may include a fast semi-random streaming access, such as model training, an ability to use derived datasets on a distributed training technology like horovod, and a cube output formatting useable by a variety of frameworks and back-ends, such as TensorFlow, Keras, PyTorch, Microsoft CNTK, and the like. Other training capabilities may also be implemented.

Supported access patterns 1204 may include programmatic and analytical access to streaming, large-scale datasets and fast, transactional and visualization for diverse geospatial datasets. Other patterns 1204 may also be implemented.

10. Improvements Provided by Certain Embodiments

In some embodiments, the presented agricultural computer platform provides the capabilities for enhancing, testing, deploying, and delivering an improved version of the AgSTAC standard transformations, code base and support documentation. It provides a scalable geoprocessing and modeling environment for testing and validation of data. Furthermore, the platform provides mechanisms for maintaining security and privacy over any controlled data shared for the development. Moreover, the platform provides interoperability with the open source geospatial technology including, but not limited to, STAC, COGs and OGC standards for spatial data and metadata.

In addition, the platform is configured to achieve optimal computational performance for supporting many concurrent accesses. At the same time, its implementation is cost effective and capable of being integrated with the existing data systems and architectures. Furthermore, it provides authentication capabilities for different levels of actions based on user groups and supports post-implementation. It further supports an open architecture for adaptation to evolving technologies. It provides a flexible integration of dynamic and static data, and it is equipped with friendly user interfaces and APIs.

What is claimed is:

1. A data processing method for implementing a scalable geospatial platform for an integrated data synthesis and artificial intelligence based exploration, the method comprising:
collecting data from one or more sources;
storing the data in a scalable geospatial platform that has visualization and querying capabilities and that is configured to receive requests for specific data and for special processing of the specific data;
receiving a request that specifies one or more data items to be retrieved from the scalable geospatial platform and that indicates a special processing that is to be performed on the one or more data items;
wherein the special processing to be performed on the one or more data items is one of: developing artificial intelligence (AI) data models, training the AI data models, validating the AI data models, or applying an AI approach to specific data;
in response to receiving the request:
retrieving the one or more data items from the scalable geospatial platform;
performing the special processing on the one or more data items to produce output data;
based on the output data, generating a graphical representation of the output data; and
based on the graphical representation of the output data, generating a graphical user interface visualizing the output data.

2. The data processing method of claim 1, wherein the special processing comprises processing and combining heterogeneous spatial datasets with varying models, formats, resolutions, projections, temporal frequency, and lineage in a scalable AI-ready environment;
wherein the special processing includes one or more of: a codification of spatial transformation and synthesis, resampling methods and processing that utilizes open geospatial standards and modern design patterns for working with cloud computing data;
wherein the cloud computing data include one or more of: STAC data, COG data, Vector Tiles data;
wherein the cloud computing data form a basis for a Digital Agriculture Industry data standard.

3. The data processing method of claim 1, wherein the scalable geospatial platform is an Agricultural Spatial-Temporal Asset Catalog (AgSTAC);
wherein the scalable geospatial platform implements one or more of: geographical information systems, geospatial data models and formats, geographic coordinate systems and projections, spatial data transformation, rasterization techniques, geospatial algorithms and related software libraries and tools, open geospatial data standards, or future technology trends;
wherein the scalable geospatial platform implements geospatial standards for data processing and predictive modeling at scale.

4. The data processing method of claim 1, wherein the scalable geospatial platform is configured to generate an on-demand dataset;
wherein the scalable geospatial platform is configured to access one or more unique spatial data layers stored in one or more storage systems and stored in one or more data formats;
wherein the one or more unique special data layers store the data in a plurality of principal data formats;
wherein the plurality of principal data formats comprise: a geospatial vector (including point data) and a geospatial raster data format;
wherein the plurality of principal data formats are used to represent environmental and machine data for vector type, imagery, typically multispectral data, and raster data;
wherein the data represented in any of the plurality of principal data formats allow maintaining the on-demand datasets in their native formats and resolutions before applying a suite of filtering processes to the on-demand datasets.

5. The data processing method of claim 1, wherein the scalable geospatial platform stores machine data that contain georeferenced measurements received from sensors of various types mounted on agricultural machines;
wherein the sensors provide imagery or raster data that contain georeferenced measurements;
wherein the sensors comprise passive and active airborne or spaceborne sensors;
wherein the agricultural machines include combines, planters, sprayers, soil samplers, tractors, irrigation units, and other equipment associated with agronomic activities;
wherein the machine data is collected while the agricultural machines are operating in agricultural fields;
wherein operating in the agricultural fields includes precision farming and collecting and analyzing data within the agricultural field.

6. The data processing method of claim 1, wherein the special processing further comprises:
processing and transforming ingested raw machine data into intermediate data types and storing transformed data in different data formats in the scalable geospatial platform.

7. The data processing method of claim 1, wherein the one or more sources include one or more of: weather data sources, field data sources, crop data sources, sensors, machines, computer networks, software applications, farmer workers, and others.

8. One or more non-transitory readable-storage media storing instructions which, when executed by one or more computing devices, cause the one or more computing devices to perform:
collecting data from one or more sources;
storing the data in a scalable geospatial platform that has visualization and querying capabilities and that is configured to receive requests for specific data and for special processing of the specific data;
receiving a request that specifies one or more data items to be retrieved from the scalable geospatial platform and that indicates a special processing that is to be performed on the one or more data items;
wherein the special processing to be performed on the one or more data items is one of: developing artificial intelligence (AI) data models, training the AI data models, validating the AI data models, or applying an AI approach to specific data;
in response to receiving the request:
retrieving the one or more data items from the scalable geospatial platform;
performing the special processing on the one or more data items to produce output data;
based on the output data, generating a graphical representation of the output data; and
based on the graphical representation of the output data, generating a graphical user interface visualizing the output data.

9. The one or more non-transitory readable-storage media of claim 8, wherein the special processing comprises processing and combining heterogeneous spatial datasets with varying models, formats, resolutions, projections, temporal frequency, and lineage in a scalable AI-ready environment;
wherein the special processing includes one or more of: a codification of spatial transformation and synthesis, resampling methods and processing that utilizes open geospatial standards and modern design patterns for working with cloud computing data;
wherein the cloud computing data include one or more of: STAC data, COGs data, Vector Tiles data;
wherein the cloud computing data form a basis for a Digital Agriculture Industry data standard.

10. The one or more non-transitory readable-storage media of claim 8, wherein the scalable geospatial platform is an Agricultural Spatial-Temporal Asset Catalog (AgSTAC);
wherein the scalable geospatial platform implements one or more of: geographical information systems, geospatial data models and formats, geographic coordinate systems and projections, spatial data transformation, rasterization techniques, geospatial algorithms and related software libraries and tools, open geospatial data standards, or future technology trends;
wherein the scalable geospatial platform implements geospatial standards for data processing and predictive modeling at scale.

11. The one or more non-transitory readable-storage media of claim 8, wherein the scalable geospatial platform is configured to generate an on-demand dataset;
wherein the scalable geospatial platform is configured to access one or more unique spatial data layers stored in one or more storage systems and stored in one or more data formats;
wherein the one or more unique special data layers store the data in a plurality of principal data formats;
wherein the plurality of principal data formats comprise: a geospatial vector (including point data) and a geospatial raster data format;
wherein the plurality of principal data formats are used to represent environmental and machine data for vector type, imagery, typically multispectral data, and raster data;
wherein the data represented in any of the plurality of principal data formats allow maintaining the on-demand datasets in their native formats and resolutions before applying a suite of filtering processes to the on-demand datasets.

12. The one or more non-transitory readable-storage media of claim 8, wherein the scalable geospatial platform stores machine data that contain georeferenced measurements received from sensors of various types mounted on agricultural machines;
wherein the sensors provide imagery or raster data that contain georeferenced measurements;
wherein the sensors comprise passive and active airborne or spaceborne sensors;
wherein the agricultural machines include combines, planters, sprayers, soil samplers, tractors, irrigation units, and other equipment associated with agronomic activities;
wherein the machine data is collected while the agricultural machines are operating in agricultural fields;
wherein operating in the agricultural fields includes precision farming and collecting and analyzing data within the agricultural field.

13. The one or more non-transitory readable-storage media of claim 8, wherein the special processing further comprises: processing and transforming ingested raw machine data into intermediate data types and storing transformed data in different data formats in the scalable geospatial platform.

14. The one or more non-transitory readable-storage media of claim 8, wherein the one or more sources include one or more of: weather data sources, field data sources, crop data sources, sensors, machines, computer networks, software applications, farmer workers, and others.

15. A data processing system comprising:
one or more computer processors;
storage media; and
instructions stored in the storage media that, when executed by the one or more computer processors, cause the one or more computer processors to perform:
collecting data from one or more sources;
storing the data in a scalable geospatial platform that has visualization and querying capabilities and that is configured to receive requests for specific data and for special processing of the specific data;
receiving a request that specifies one or more data items to be retrieved from the scalable geospatial platform and that indicates a special processing that is to be performed on the one or more data items;
wherein the special processing to be performed on the one or more data items is one of: developing artificial intelligence (AI) data models, training the AI data models, validating the AI data models, or applying an AI approach to specific data;
in response to receiving the request:
retrieving the one or more data items from the scalable geospatial platform;
performing the special processing on the one or more data items to produce output data;
based on the output data, generating a graphical representation of the output data; and
based on the graphical representation of the output data, generating a graphical user interface visualizing the output data.

16. The data processing system of claim 15, wherein the special processing comprises processing and combining heterogeneous spatial datasets with varying models, formats, resolutions, projections, temporal frequency, and lineage in a scalable AI-ready environment;
wherein the special processing includes one or more of: a codification of spatial transformation and synthesis, resampling methods and processing that utilizes open geospatial standards and modern design patterns for working with cloud computing data;
wherein the cloud computing data include one or more of: STAC data, COGs data, Vector Tiles data;
wherein the cloud computing data form a basis for a Digital Agriculture Industry data standard.

17. The data processing system of claim 15, wherein the scalable geospatial platform is an Agricultural Spatial-Temporal Asset Catalog (AgSTAC);
wherein the scalable geospatial platform implements one or more of: geographical information systems, geospatial data models and formats, geographic coordinate systems and projections, spatial data transformation, rasterization techniques, geospatial algorithms and related software libraries and tools, open geospatial data standards, or future technology trends;
wherein the scalable geospatial platform implements geospatial standards for data processing and predictive modeling at scale.

18. The data processing system of claim 15, wherein the scalable geospatial platform is configured to generate an on-demand dataset;
wherein the scalable geospatial platform is configured to access one or more unique spatial data layers stored in one or more storage systems and stored in one or more data formats;
wherein the one or more unique special data layers store the data in a plurality of principal data formats;
wherein the plurality of principal data formats comprise: a geospatial vector (including point data) and a geospatial raster data format;
wherein the plurality of principal data formats are used to represent environmental and machine data for vector type, imagery, typically multispectral data, and raster data;
wherein the data represented in any of the plurality of principal data formats allow maintaining the on-demand datasets in their native formats and resolutions before applying a suite of filtering processes to the on-demand datasets.

19. The data processing system of claim 15, wherein the scalable geospatial platform stores machine data that contain georeferenced measurements received from sensors of various types mounted on agricultural machines;
wherein the sensors provide imagery or raster data that contain georeferenced measurements;
wherein the sensors comprise passive and active airborne or spaceborne sensors;
wherein the agricultural machines include combines, planters, sprayers, soil samplers, tractors, irrigation units, and other equipment associated with agronomic activities;
wherein the machine data is collected while the agricultural machines are operating in agricultural fields;
wherein operating in the agricultural fields includes precision farming and collecting and analyzing data within the agricultural field.

20. The data processing system of claim 15, wherein the special processing further comprises:
processing and transforming ingested raw machine data into intermediate data types and storing transformed data in different data formats in the scalable geospatial platform;
wherein the one or more sources include one or more of: weather data sources, field data sources, crop data sources, sensors, machines, computer networks, software applications, farmer workers, and others.
